(19) United States
(12) Patent Application Publication
(10) Pub. No.: US 2007/0260605 A1
(43) Pub. Date: Nov. 8, 2007

(54) Multiple-Listing Referral-Tracking System

(75) Inventors: John G. Norman, Cambridge, MA (US); Stanley M. Ward II, South Hamilton, MA (US)

Correspondence Address: FOLEY HOAG, LLP;PATENT GROUP, WORLD TRADE CENTER WEST, 155 SEAPORT BLVD, BOSTON, MA, 02110, US

(73) Assignee: H Three, Inc., Cambridge, MA (US)

(21) Appl. No.: 11/278,334

(22) Filed: Mar. 31, 2006

(51) Int. Cl. G06F 17/30

(52) U.S. Cl. 707/10

(57) ABSTRACT

A referral-tracking system accepts listings from originators and generates referral identifiers that represent referrals of those listings. A referral identifier represents a referral by the originator or by someone who, after receiving a listing identifier from an s originator or someone else, applies to the system to be recognized as a referrer and has accordingly been issued a referral identifier that associates that requester with a listing to be referred. By noting the requests that it receives for referral identifiers, the system can track a chain of referrals from a requester to the person who ultimately fulfills the listing. Some identifiers may be multi-referral identifiers, which represent referrals of multiple listings and can be used by the requester to refer multiple listings simultaneously to the same referral-identifier recipient.

### CROSS-REFERENCE TO RELATED APPLICATIONS

The present application is related to commonly assigned co-pending U.S. patent application Ser. No. 11/212,265, which was filed on Aug. 26, 2006, by Rowe et al. for Referral Tracking and is hereby incorporated by reference.

The present application is also a related to commonly assigned co-pending U.S. patent application Ser. No. 11/092,397, which was filed on Mar. 29, 2005, by Rowe et al. for Referral Tracking and is hereby incorporated by reference.

### BACKGROUND OF THE INVENTION

1. Field of the Invention

This disclosure relates to the representation and tracking of personal-contact networks used to propagate listings and referrals of listings.

2. Background Information

Widely disseminated but relatively indiscriminate media such as newspapers are often used to elicit offers to take a job, make an investment, buy property, etc. But the most effective and efficient way to elicit interest often turns out to be the use of personal-referral networks: acquaintances communicate an opportunity's availability selectively to people they know. Recognizing this, many enterprises disseminate job listings to their contacts, such as existing employees, and provide incentives, such as employee-referral bonuses for identifying successful candidates.

The Internet and other computer networks have enhanced that approach's efficiency, and network services have evolved that employ that approach. In one type of service, for example, a person wishing to create and propagate a listing (such as a recruiter who wants to elicit job applicants) uploads the listing to a central server. The recruiter also sends the central server a list of e-mail addresses of some of the recruiter's contacts, and the server thereupon sends those contacts messages that describe the listing and give the URL of a web page where the messages' recipients can express interest in the offer and/or provide the e-mail addresses of some of their own contacts-to whom the central server further propagates the listing.

Such services lend the speed of Internet communication to the targeted propagation of personal referrals. Since the central server receives the referrals and sends the resultant offer-eliciting messages, such services can provide an automated way of implementing rewards systems and/or keeping track of which referral sources prove most effective.

Such automation can be achieved without requiring that the recruiter and other referring parties provide their contacts to the central server. Systems have been developed in which, instead of sending the central server a contact list, the recruiter or other referring party obtains from the central server an identifier value that the central server associates uniquely with the combination of a listing and a referrer. Then, instead of having the central server send the listing-containing message, the referrer can send the message directly (for example, via his or her own e-mail system) and include the identifier in the message. When the recipient wants to inform one of his own contacts of the listing, he requests his own unique identifier from the server and includes in the request the identifier he received from the referrer. In issuing the new identifier, the central server in such a system links the new identifier with the identifier the recipient submitted and can thereby track the referral chain. A recipient who instead wants to express interest in the listing—e.g., apply for the job—similarly includes the referrer-supplied identifier in an application that he sends the central server for that purpose.

### SUMMARY OF THE INVENTION

We have identified a way to improve this basic approach: enable multiple listings to be distributed simultaneously. Specifically, the referral-tracking system can be so arranged that the referral identifiers it issues can represent referrals of more than one listing by the referring party. The listing's originator (e.g., the recruiter in the case of a job listing) or other referrer can then send a message incorporating the multi-referral identifier to any number of recipients via e-mail, for example. The recipient can choose to express interest in one or more of the listings associated with a multi-referral identifier. Alternatively, or in addition, the recipient may want to inform his own contacts about some of the listings. He can do so by requesting his own multi-referral identifier, which associates him with those listings that he wishes to inform his contact about.

This approach has several advantages, among which is that it streamlines the process of passing referrals on; as will be seen below, a recipient can be easily presented with multiple listings from which to choose and be given a compact mechanism for forwarding the listings he has chosen.

Further advantages will be appreciated from the following description.

### BRIEF DESCRIPTION OF THE DRAWINGS

The invention description below refers to the accompanying drawings, of which:

FIG. 1 is a block diagram of one type of workstation that a computer system implementing the present invention's teachings may include;

FIG. 2 is an illustration of an exemplary embodiment of data tables in which a multiple-listing referral-tracking system stores user identifiers, listing identifiers, referral identifiers, and multi-referral identifiers;

FIG. 3 is a screen capture of an exemplary embodiment of a web page for entering information about a listing;

FIG. 4 is a screen capture of an exemplary embodiment of a web page for entering information about a reward associated with a listing;

FIG. 5 is a flow chart illustrating an exemplary process by which a multiple-listing referral-tracking system responds to the entry of a listing;

FIG. 6 is a screen capture of an exemplary embodiment of a web page presented to an originator presenting the originator with all the listings created by the originator;

FIG. 7 is a screen capture of an exemplary embodiment of a web page that can be used by an originator to choose which listings to refer to a contact;

FIG. 8 is a screen capture of an exemplary embodiment of an e-mail message containing a multi-referral identifier associated with a plurality of listings that the originator intends to forward to a contact;

FIG. 9 is a screen capture of an exemplary embodiment of a web page presented to a requester who sends the referral system a message incorporating a referral identifier;

FIG. 10 is a screen capture of an exemplary embodiment of a web page presented to a requester who sends the referral system a message incorporating a multi-referral identifier;

FIG. 11 is a screen capture of an exemplary embodiment of a web page for entering information about a user who has indicated to the system his desire to express interest in a listing;

FIG. 12 is a screen capture of an exemplary embodiment of a web page for entering information about a requester who has indicated to the system his desire to further refer at least one listing;

FIG. 13 is a flow chart illustrating an exemplary process by which a multiple-listing referral-tracking system responds to the receipt of a message from a requester;

FIG. 14 is a screen capture of an exemplary embodiment of a web page presented to a requester after the requester identifies himself to the system;

FIG. 15 is a screen capture of an exemplary embodiment of a web page through which a requester can select a plurality of listings to refer to a contact;

FIG. 16 is a screen capture of an exemplary embodiment of an e-mail confirming that a requester has expressed interest in a listing;

FIG. 17 is a screen capture of an exemplary embodiment of a web page indicating that an originator has been notified of a requester's interest in a listing;

FIG. 18 is a screen capture of an exemplary web page for use when an originator is sent a multi-referral identifier in a web page;

FIG. 19 is a screen capture of an exemplary web page for use when a requester is sent a multi-referral identifier in a web page;

FIG. 20 is a flow chart of alternative routines that a multiple-listing referral-tracking system can use to respond to a user's entering one or more listings; and

FIG. 21 is a flow chart of further alternative routines that a multiple-listing referral-tracking system can use to respond to a user's entering one or more listings.

### DETAILED DESCRIPTION OF AN ILLUSTRATIVE EMBODIMENT

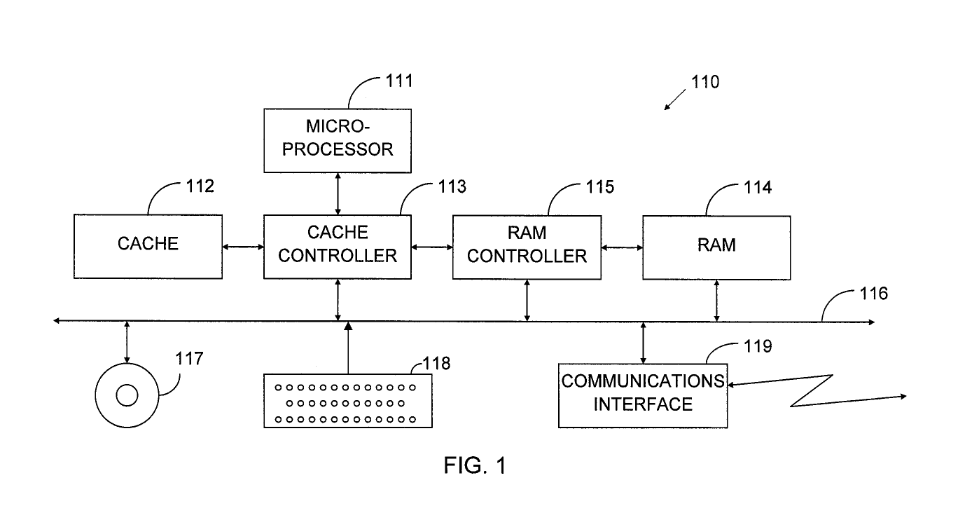

Referral-tracking approaches that employ the present disclosure's teachings will ordinarily be implemented in computer systems. Computer systems vary widely in architecture, so although FIG. 1 depicts one type of workstation 110 that such a computer system may include, most will differ from it in one or more details.

Data that a microprocessor 111 uses and instructions to be executed by the micro-processor 111 may reside in on-board cache memory or be received from further cache memory 112, possibly through the mediation of a cache controller 113. That controller 113 can in turn receive such data and instructions from system read/write memory (“RAM”) 114 through a RAM controller 115 or from various peripheral devices through a system bus 116. The memory space made available to an application program may be “virtual” in the sense that it may actually be considerably larger than RAM 114 provides. So the RAM contents are often swapped to and from a system disk 117.

Additionally, the actual physical operations performed to access some of the most-recently visited parts of the process's address space often will actually be performed in the cache 112 or in a cache on board microprocessor 111 rather than on the RAM 114. Those caches would swap data and instructions with the RAM 114 just as RAM 114 and system disk 117 do with each other.

Independently of the particular memory arrangement that a particular workstation employs, it will often include some type of user-input device such as a keyboard 118 or mouse (not shown). By using such devices, the user enters data and commands as appropriate.

The computer system may include more than one such microprocessor, and a given one of the microprocessors may share some or all of the persistent-storage facilities with one or more other such microprocessors. The persistent-storage facilities will typically store the instructions that configure the computer system as the multiple-listing referral-tracking system described below, but such instructions, possibly of the type to be executed by a virtual machine that the computer system can be software-configured to implement, can in principle be loaded directly into memory from a remote source through a communications interface 119. One or more processors may use one or more such communications interfaces to implement the central-server function described below.

The system described herein may be employed to propagate or distribute any kind of listings or offers through the personal-contact networks of the listings' originator(s) and recipient(s). For example, listings may be job listings, created by recruiters or hiring managers searching for an employee to fill a position. Alternatively, listings may be created by people seeking contractors to provide specified services. Listings may instead relate to real estate or other property, such as antiques or collectibles, offered for sale or rent by an owner, seller, or broker. Or they may be created by a prospective buyer seeking an opportunity to make an offer on real estate or other property. Furthermore, a user may group multiple types of listings together when referring a group of listings to a contact. For example, one or more listings in a group may be job listings while other listings in the group may be real-estate listings, furniture listings, clothing listings, or any other type of listing or combination of types of listings. The system described may be employed in any instance in which an originator of at least one listing wishes to distribute any kind of offer, request, or opportunity through his or her own personal-contact network and the personal-contact networks of the listing's recipient(s). The above examples should be understood to be exemplary rather than exhaustive.

The following description of an exemplary embodiment of the invention presents an example in which the originators of each listing are employers or the agents of employers seeking to fill one or more job positions. In the example, each “listing” represents the job position to be filled. A recipient of a group of listings may choose to express interest in one or more of the job positions himself or herself and/or may choose to refer others who may be interested in applying for the positions or a subset of the positions. In some cases, the person or other entity that originates a listing is not the same as the person who decides which applicant (job applicant, bidder, etc.) will be chosen to fulfill the listing, and both may be different from the person or entity that issues any resultant awards. However, the description below will use the term “originator” collectively to refer to the entity or entities that perform one or more of such functions.

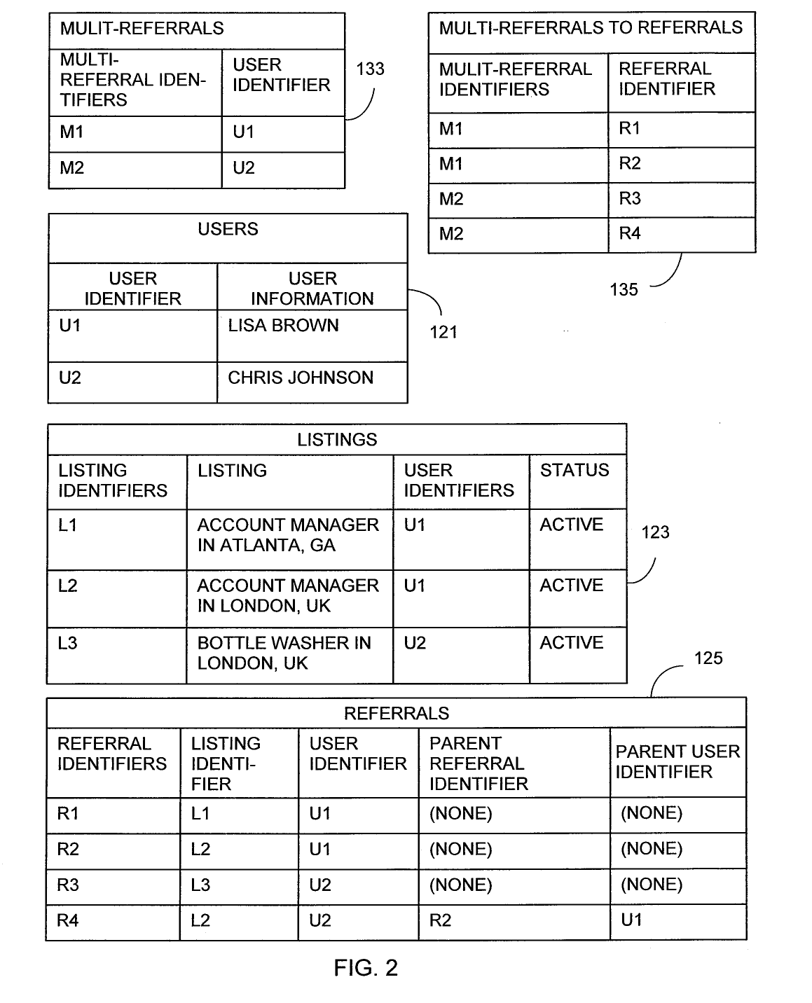

In this illustrated embodiment, the system creates an account unique to the particular originator prior to allowing the originator to enter listing information. To edit or retrieve information pertaining to the listings that the originator has created or received from others, the originator may subsequently access his or her account by using a password. The system may create an identifier associated with the originator (and, as will be seen, other users) in its database so that this information can be accessed in the future and to allow the system to associate the user with listings. For example, the identifier U1 in table 121 of FIG. 2 was created to identify an originator named Lisa Brown. For each listing created by Lisa Brown, the identifier U1 will be used to associate her with the listing. In alternative embodiments, information about the originator may be entered along with information about the listing. In such embodiments, an originator may not necessarily need to create an account.

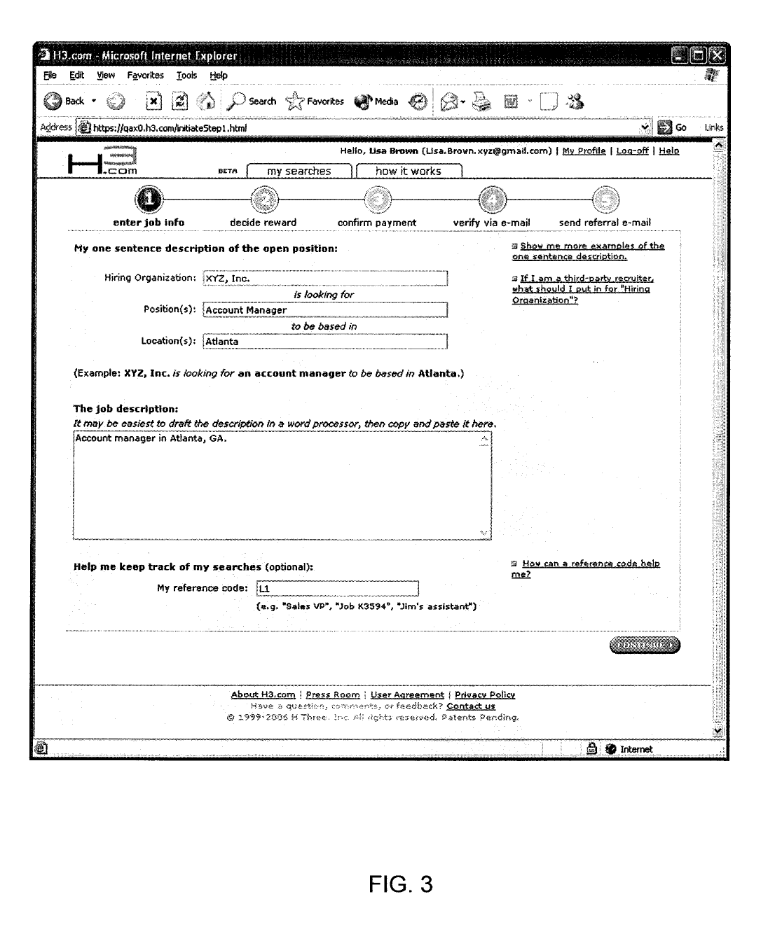

In the illustrated embodiment, an originator can access the system via the Internet and, using a web-page interface, create a plurality of listings that the originator wants to propagate. FIG. 3 depicts an example web-page interface for creating a listing. The information entered in this web page is used to create a listing identifier such as the ones stored in listing table 123 of FIG. 2. The example entries shown in FIG. 3, for example, correspond to the entry labeled L1 in table 123 of FIG. 2, as discussed below.

An originator can submit entered information by clicking on the “continue” button illustrated in FIG. 3. After clicking on this button, the originator's browser sends the system a message containing the information entered in the interface. In alternative embodiments, the originator may supply information about the listings by sending an e-mail message or any other transmission to the system. The e-mail message may, for example, be a form e-mail from which the system can automatically read information about a listing.

In some embodiments, an originator may enter multiple listings simultaneously; for example, in a specially formatted e-mail message containing listing separators that the system can identify as the end of one listing and the beginning of another listing. In other embodiments, a system-to-system transfer may operate to automatically without human intervention. A corporation's internal job-application-monitoring system, for example, may send its job listings to a referral-tracking system automatically when they meet certain criteria, such as having been offered internally for more than a predetermined length of time. For the purposes of the present discussion, any listing-describing information received by the system in any way, including via a web-page interface or via e-mail, is considered a listing-containing message from an originator.

Each listing may include information about the organization or person on whose behalf the listing is created, e.g., an employer having a plurality of job openings. Each listing may also include a job title and/or a brief description of the job as well as the job's geographical location and any other information pertinent to the offer described. The originator may also assign each listing a reference code that is to be included in further communication about that listing between the originator and the system. (Although FIG. 3 depicts the originator's reference as being the same as the listing identifier, “L1,” that the system used for that listing, this can, of course, be any value.)

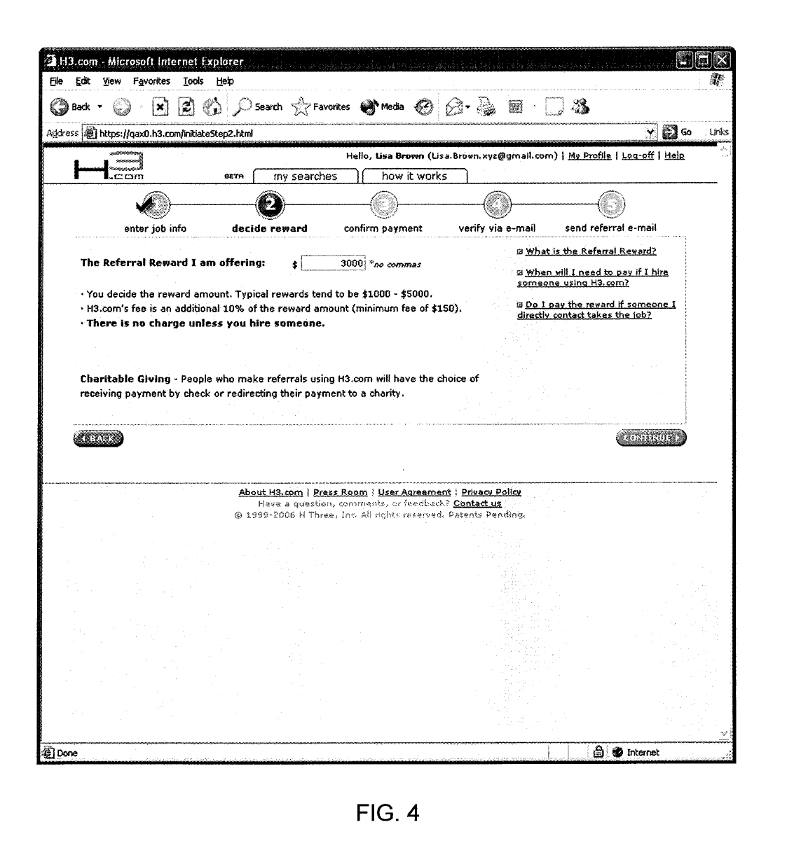

Some embodiments may include provisions for associating rewards with a listing. Rewards may be offered, for example, by the organization or person on whose behalf the listings are created. In the case of a job listing, the reward would typically be awarded when a listed position is filled successfully through the system. If one listing invites applicants for more than one job position, a reward may be distributed each time a referred candidate is hired for one of the positions. As will be described below, that system may determine which requesters will receive a share of the reward. FIG. 4 depicts an exemplary web-page interface that can be used to enable the originator to submit a reward amount for a listing. In the illustrated embodiment, a recipient who qualifies for a share of the reward has the option of accepting payment of the share of the reward or of redirecting that payment to a charity. The system may allow the originator to recommend a charity to which the reward should be directed. In some embodiments, the originator selects the recommended charity from a list of charities that the system provides. In other embodiments, the originator may select any charity he desires by entering identifying information for that charity.

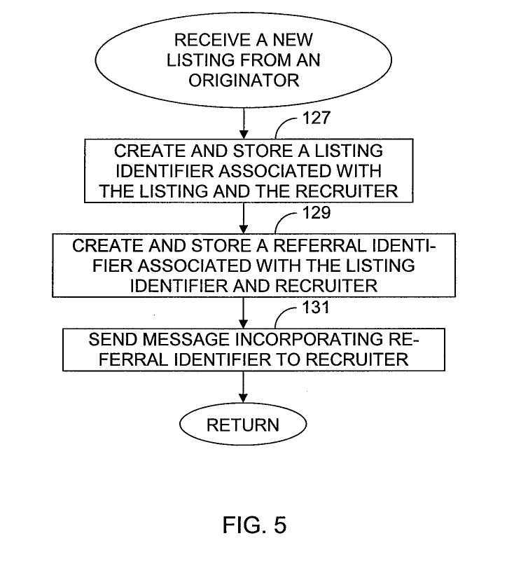

FIG. 5 is a flow chart that depicts how the illustrated embodiment responds when it receives a listing-containing message from an originator. Upon receipt of the listing-containing message, the exemplary system generates a listing identifier, such as “L1” in FIG. 2's table 123, associated with the listing, the originator, and the rewards and stores this identifier in a database (block 127). In the illustrated embodiment, originators submit only one listing at a time, but in other embodiments that allow multiple simultaneous listing submissions, a listing identifier may be generated for each listing submitted.

As block 129 indicates, the illustrated embodiment then creates a “referral identifier,” which is part of the mechanism by which the system tracks referral chains and thereby knows whom to assign the posted awards. As will be explained in more detail below, a person who wants to qualify to get credit for having referred one or more listings requests a referral identifier and specifies one or more listings that he wants to qualify to get credit for referring. In response, the system issues a referral identifier that it associates with that listing set and with the requester as a potential referrer.

As will also be explained in more detail below, the requester sends the thereby-obtained referral identifier to anyone to whom he refers the listing, and the recipient can submit that referral identifier to the system to elicit consideration of the recipient for the job or jobs—or request another referral identifier, one that will qualify that recipient as a potential referrer. By thus receiving back referral identifiers that it has associated with respective potential referrers, the system can track who referred what listings to whom.

To begin the referral chain, the originator will need a referral identifier even though the originator will not typically qualify for the reward. However, although FIG. 5's block 129 indicates that the illustrated embodiment automatically responds to a listing's creation by generating a referral identifier associated with the originator, some embodiments may instead defer referral-identifier creation until the originator makes a separate request for one. One reason for such deferral could be that the originator may in some cases end up always referring a given listing together with another rather than by itself, in which case the originator may use only a single referral identifier for a certain set of listings and not necessarily a separate referral identifier for each one. As will be seen below, though, the particular database design used by the illustrated embodiment requires a separate referral identifier for every referred listing, even if some are not referred separately, so it makes sense to create the referral identifiers automatically when the listings are created.

Referral identifiers “RI” and “R2” in the first two rows of FIG. 2's referral table 125 reflect the results of Lisa Brown's creating two listings: that table associates these identifiers, which may, for example, be generated as Universally Unique Identifiers (UUIDs), with listings L1 and L2, respectively, and with U1 (Lisa Brown) as the potential referrer.

After these identifiers are generated and stored in the database, the system sends the originator a message incorporating the referral identifier associated with the entered listing (block 131). (Again, some embodiments may not send the referral identifiers automatically like this, i.e., without a separate request from the originator.) The message can be an e-mail message containing a Uniform Resource Locator (“URL”) that incorporates the referral identifier associated with the listing. In embodiments that allow multiple listings to be entered simultaneously, if multiple listings are entered at once, the system could supply the originator with a message containing a series of referral identifiers, one for each listing; a sequence of messages, one for each listing, each containing a single referral identifier; a multi-referral identifier associated with all of the entered listings; or some combination of these options. As will be explained in due course, the originator can use the supplied multi-referral identifier to send multiple listings simultaneously to the same contact.

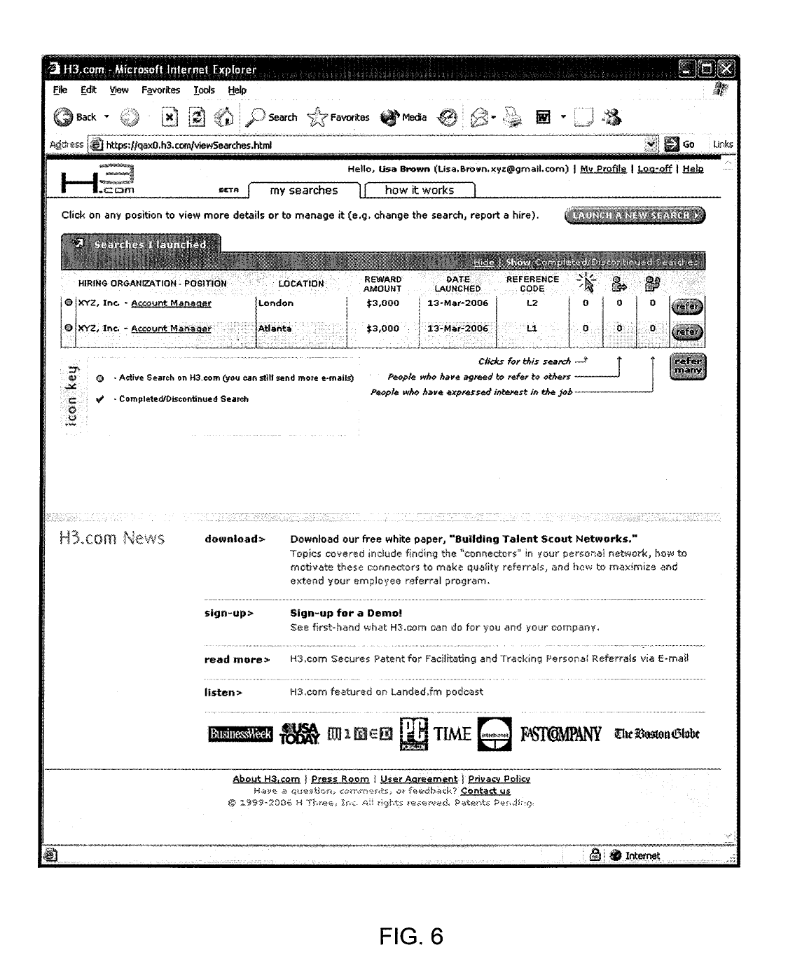

The system remembers the identifiers that it creates, so the originator can log back on at a later date to make further referral of previously created listings. When the originator then later logs on, the system may provide the originator an interface, such as the one depicted in FIG. 6, that displays the listings the originator has created. In some embodiments, such an interface may also present other listings associated in some way with the originator (e.g., listings that the originator has expressed interest in or previously referred to others). Through this interface, the originator can select one or more job listings to forward.

In the illustrated interface, the originator can forward a single listing by clicking the “refer” button in the row associated with that single listing. Pressing this button, in the illustrated web-based embodiments, causes the originator's browser to send the system a message identifying the listing and indicating that the system should issue a referral identifier that qualifies the requester (here, the original originator) as a potential referrer of that listing. This message can be in any format recognized by the system. In the illustrated web-based example, the message is in the form of an HTTP message (e.g., a POST command). In this case, in which the requester is the originator requesting the referral identifier from a web page dedicated to originator use, that message actually identifies the listing simply by including the referral identifier associated with the listing and the originator, i.e., the very referral identifier that the requester is requesting. The system then sends the originator an e-mail message containing a URL that incorporates that referral identifier.

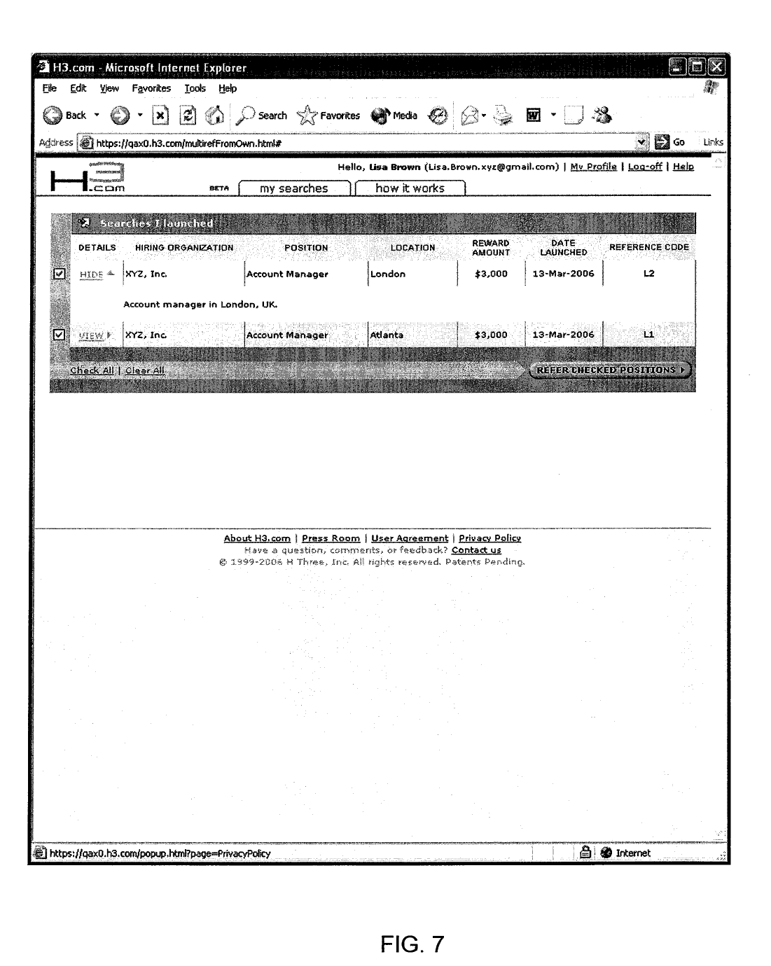

Alternatively, the originator can press the “refer many” button to be directed to an interface such as the one illustrated in FIG. 7. (Of course, such an interface need not have to be presented in a web page separate from that of FIG. 6.) In this interface, the originator can check the boxes of listings he wants to forward and uncheck the boxes for listings he does not want to forward. Then, if the originator clicks on the button labeled “Refer Checked Positions,” in the illustrated embodiment, his browser sends the system a message identifying the checked listings. This message can be in any format recognized by the system. In the illustrated examples, it takes the form of an HTTP message containing a list of referral identifiers associated with the checked listings and the originator. The system then generates a multi-referral identifier associating all of the listings with the requester.

In the illustrated embodiment, each time a user requests a multi-referral identifier for a set of listings, the system generates a new multi-referral identifier regardless of whether a multi-referral identifier associated with the user and the same set of listings has been previously generated. In other embodiments, the system may be designed to only generate one multi-referral identifier associated with the user and that set of listings. In such an embodiment, the system may search its database to determine the existence and identity of any such previously generated multi-referral identifier. If one is found, the system would proceed using the previously generated multi-referral identifier in place of s a newly generated multi-referral identifier. If none is found, the system would generate a new multi-referral Identifier.

As FIG. 2 indicates, the particular database design employed by the illustrated embodiment uses one table, i.e., table 133, to associate the multi-referral identifier (here, M1) with the potential referrer (U1, i.e., Lisa Brown) and uses another, table 135, to associate the referral identifier with the listings. Moreover, instead of using listing identifiers in table 135 to specify the listings with which that table associates the multi-referral identifier, the illustrated embodiment uses (single-) referral identifiers. This is the database-design feature mentioned above as requiring allocation of a single-referral identifier with each listing that is to be referred, even if it never gets referred individually. Obviously, the present invention's teachings can be practiced without using any of these features.

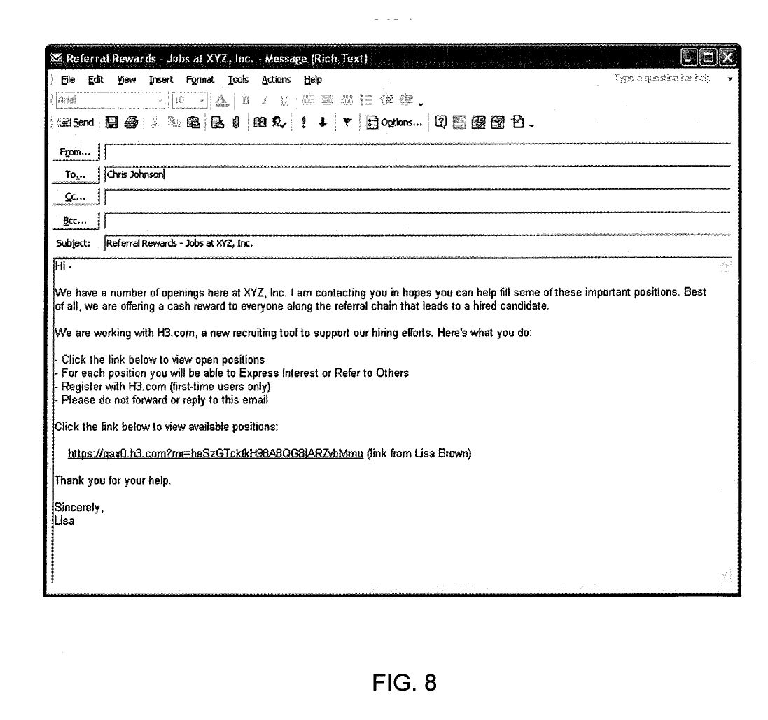

After creating the necessary identifiers, the system sends the originator an e-mail message that contains a URL that incorporates the multi-referral identifier associated with the selected listings. When the illustrated embodiment provides an identifier to a user, it includes the URL in the reference field of a hyperlink that the e-mail message's body contains, as FIG. 8 illustrates. As that drawing shows, the hyperlink may display that URL explicitly; the URL is https://qax0.h3.com?mr=heSzGTckfkH98A8QG8|ARZvbMmU. We assume for the sake of this example that heSzGTckfkH98A8QG8|ARZvbMmU is a multi-referral identifier that the system generated when Lisa Brown chose to refer multiple listings she entered; i.e., the illustrated embodiment incorporates that identifier by simply including it literally without transformation in the URL as the value of a parameter named “mr.”

But not all embodiments that incorporate a referral or multi-referral identifier in a URL will necessarily embed it in a hyperlink. In some, for example, an e-mail message may simply include a plain-text URL for the recipient to copy and paste into the address bar of a web browser. Instead of containing the identifier explicitly, the URL may contain it in any transformed, transposed, or other form from which the identifier can be inferred. For the purposes of this discussion, a message of any kind (including information passed via a web-page interface or via e-mail), a URL, or a hyperlink that includes a referral identifier or multi-referral identifier in any form that can be derived by the system (e.g., an exact copy of the identifier, an encrypted transformation of the identifier, a hash key signifying the location of the identifier, etc.) should be understood to “incorporate” that identifier.

Also, although the illustrated embodiment employs only a single parameter to incorporate multi-referral or single-referral identifiers, some embodiments that incorporate a single- or multi-referral identifier in a URL may employ a plurality of parameters collectively for that purpose. Instead of generating a separate UUID as the identifier for a given referral, for example, some embodiments may use as the identifier a (single/multi-referral ID, user ID) pair or a (listing ID(s), user ID, parent ID(s)) tuple (in which the parent IDs are a reserved null value for each listing for which the referrer is an originator). A multi-referral identifier could also be implemented as a (referral IDs, user ID) tuple in which each referral identifier associated with the multi-referral identifier is identified in the referral IDs list. In such embodiments, it may prove convenient to use separate parameters for respective components of the (composite) identifier.

And parameters are not the only way to incorporate a referral or multi-referral identifier in a URL. For example, some systems may provide a separate server page for each listing or each set of listings that are referred to together in multi-referral identifier, in which case the listing ID(s) component of a composite identifier could be represented by the name of that page, while the user component would probably still be passed as a parameter. Such a URL for both of Lisa Brown's listings (L1 and L2) could look something like “http://serverName.com/XYZAccountManager(Atlanta)_XYZAccountManager(London) .asp?u=heSzGTckfkH98A8QG8|ARZvbMmU.”

FIG. 8 depicts a message that contains the hyperlink incorporating a referral identifier. This message illustrates a multi-referral containing message; however, similar messages can be used with single-referral identifiers. A message incorporating a referral identifier can be configured to suit a particular user's needs. For instance, if an originator refers only jobs from one hiring organization, the message can be branded to reflect that hiring organization.

A referral-identifier-containing message may contain all or some of the originator-entered information about the listing. The message may also contain information about any reward offered by the originator or the organization or person on whose behalf the listing was created.

When the system sends the referral-identifier-containing message to the originator, it may also provide the originator a web page providing the originator with additional information and instructions, including the option to view information about the listing or listings.

When the originator receives the referral-identifier-containing message from the system, he or she can then send it using his or her own e-mail system to any number of recipients who may be interested in the listing or listings or know someone who is. These recipients may be selected from the originator's own personal contacts. Note that this allows the originator to protect his or her personal-contact network by forwarding the referral-identifier-containing message without having to provide recipients' e-mail addresses to the system. The system need not receive the identities or e-mail addresses of the recipients that the originator has chosen unless the recipients decide to identify themselves to the system in order to apply for a job or get credit for a referral.

The intention is that, if the contact wants to participate in the search and get credit for doing so, he will identify himself to the central server, identify the listing or listings in which he is interested, and be issued a further identifier, which the central server will associate with that contact. For each listing in which the contact expresses interest (either in the job itself or in forwarding the listing on to other contacts) the system will create a new referral identifier associated with both the contact and the listing. In the illustrated embodiment, a referral identifier is created when a contact expresses interest in a listing, but in other embodiments the system may not generate a referral identifier unless the contact expresses interest in forwarding a listing to another person. Each of the referrals represented these new referral identifiers will be treated as a child of a referral represented by the referral identifier associated with the person who referred the listing to the contact. If the contact chooses to refer multiple listings to a subsequent contact, the system creates a multi-referral identifier associated with the contact and the new referral identifiers associated with the chosen listings. Subsequent identifier recipients will do the same, and through the parent-child relationships of the referral identifiers, the system can track referral chains and identify the one that ultimately results in a job being filled. This further referral process is described more fully below.

To describe this further referral process, let us consider a scenario in which there is more than one originator. In particular, let us assume that another user, Chris Johnson, has registered with the system, as the second record in FIG. 2's user table 121 indicates, and that Chris has created the listing represented by the listing table 123's third record. The illustrated embodiment will therefore have created the referral identifier that referral table 125's third entry represents and will have sent it to Chris as a hyperlink in an e-mail message similar to the one that FIG. 8 shows having been sent to Lisa (and put by her in an e-mail message that, as we will see below, she will send to Chris.)

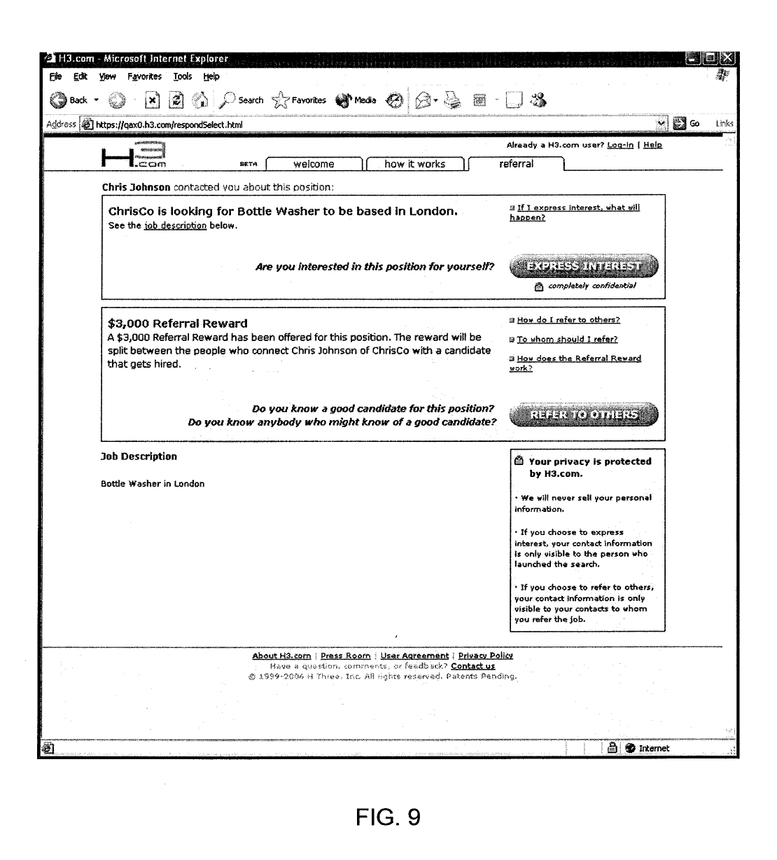

Let us suppose that Chris places the body of that message, including the hyperlink, in an e-mail message to one Mary Livingston. As FIG. 2 suggests, this referral can occur in the illustrated embodiment without introducing Mary to the system. Although recipients of a single- or multi-referral identifier will be described in connection with the illustrated embodiment as clicking on a hyperlink or button to submit to the system the identifiers they receive, other embodiments may additionally or instead accept other modes of submission. For example, the recipient may copy a URL into a web browser's address bar or send an e-mail message containing this identifier. Or a plug-in module in the client's e-mail client may detect a referral-tracking-system message, respond to such a message's receipt by presenting the user the options that the illustrated embodiment's web page does in FIG. 9, and respond to a resultant user input by sending the system the received identifier and the user's information, possibly without the user's having to enter that information manually.

In this scenario, though, Mary clicks on the hyperlink in the e-mail message that Chris forwarded, and her web browser sends the system a message that contains (either explicitly or in encoded form) the identifier incorporated in that hyperlink. In this case, in which the referral identifier she received is a single-referral identifier, she is directed to a web page, such as the one illustrated in FIG. 9, that describes the details of the single listing associated with the single-referral identifier and includes controls by which she can choose to either express interest in the listing or “refer” the listing, i.e. request a referral identifier that associates the her with the listing.

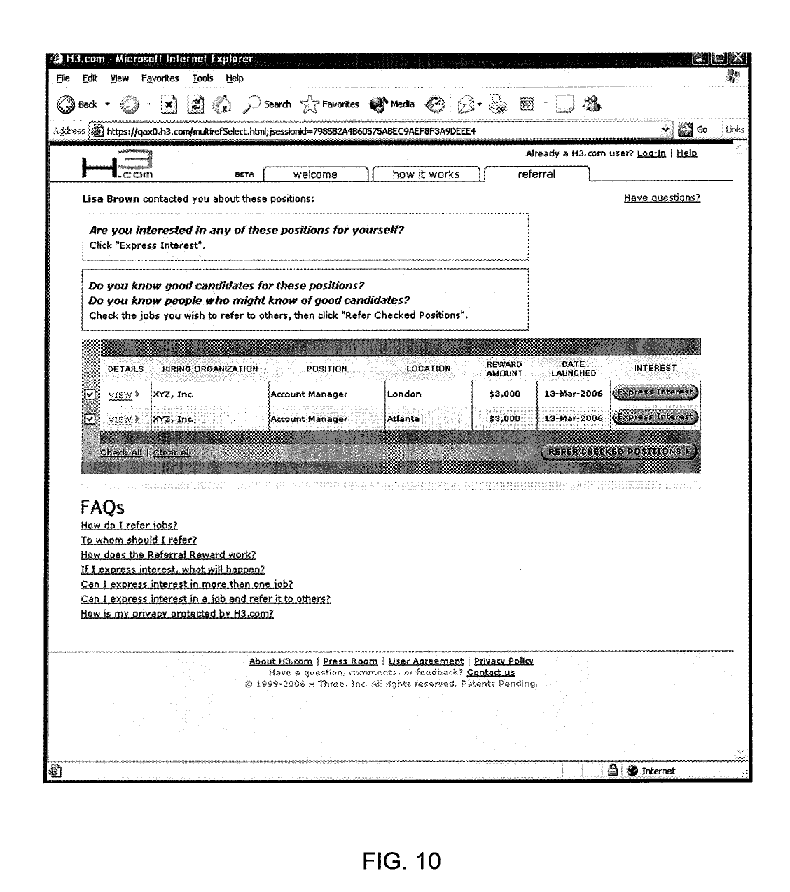

Before we see what happens when she does so, let us consider what happens when Lisa Brown uses her multi-referral identifier (M1 in FIG. 2) to refer the two job listings that she created to Chris Johnson and Chris clicks on the hyperlink he thereby receives in the e-mail message she forwards him. Since the identifier is a multi-referral identifier, he is directed to a web page, such as the one illustrated in FIG. 10, that includes controls by which the requester (here, Chris) can choose to either express interest in one of the listings associated with the multi-referral identifier or to “refer” one or more of these listings, i.e. to request a (potentially multi-) referral identifier that associates the requester with the one or more listings thusly specified. In some embodiments, the user may be directed to a web page similar to the one in FIG. 10 even if the identifier is a referral identifier identifying only one listing.

The web page illustrated in FIG. 10 allows a requester to select one or more listings by checking the boxes next to those listings. If all of the listings identified on this web page originate from the same hiring organization, in some embodiments the web page can be specially branded to reflect that hiring organization. This web page also allows a user to obtain more information about a listing by clicking on the “view” link under the details column. The information available by clicking the “view” link can include any information that the originator of the listing entered when the listing was originally entered and any updates entered by the originator of the listing or by another authorized user. In some embodiments, clicking on the “view” link may direct the user to a web page devoted to the listing similar to the page illustrated in FIG. 9.

When a requester clicks on a “refer position,” “refer checked positions,” or “express interest” button, a message is sent to the system identifying which listings have been selected and what action is to be performed (e.g., refer the selected listings or express interest in a listing). In some embodiments, this interface may also allow the requester to refer multiple listings simultaneously by, for instance, also including an “express interest in checked positions” button. In the illustrated web-based embodiment, that message identifies the selected listings by including corresponding referral identifiers selected from among referral identifiers listed in the HTML document that the system sent the requester to define the button-containing web page.

The list of referral identifiers sent to the system in response to the requester clicking one of FIG. 10's “express interest” or “refer checked positions” buttons comprises one referral identifier that associates a selected listing with the person who referred it to the requester.

In other embodiments, the list of referral identifiers may include a referral identifier for every listing whether check or unchecked, and the message can include a bitmap that the system can use to determine which listings are checked (e.g., each referral identifier with a position matching a 1 in the bitmap corresponds to a checked listing). In still other embodiments, instead of being sent one message containing both a list of identifiers and an action to be performed, the system may be sent a message each time the requester checks or unchecks a box and a final message indicating an action to be performed when the requester clicks on a button. In such an embodiment, the message sent each time the requester checks or unchecks a box would identify the listing associated with that box to the system. In such an embodiment, if the system knows the originating state of the boxes, it can track the boxes as they change states. So, when the requester presses the “refer checked positions” button the system is only sent a message identifying the action to be performed and can derive the selected listings from the tracked information. Any other method can be used so long as the system can identify an action to be performed and the listings selected by the requester.

The interface of FIG. 9, which allows the user to refer or express interest in one listing, accomplishes this, as the FIG. 10 interface does, by sending a message to the central server identifying a referral identifier associated with the listing and the action to be performed.

In some embodiments, rather than providing the requester with a single hyperlink such as the one in FIG. 8 that directs the requester to a web page such as those of FIGS. 9 and 10 that present options to the requester, the referral-containing message may itself be configured to provide the requester with such options. For example, the message may include multiple URLs, each incorporating an identifier along with an additional parameter corresponding to a respective one of the choices presented to the requester. These URLs may be provided in the message in plain text or embedded in hyperlinks, including hyperlinks having an image attribute so that they appear as buttons or other icons in the referral-containing message. Clicking on such a URL sends a message to the system that incorporates the identifier along with an indication of the choice the requester has thereby made.

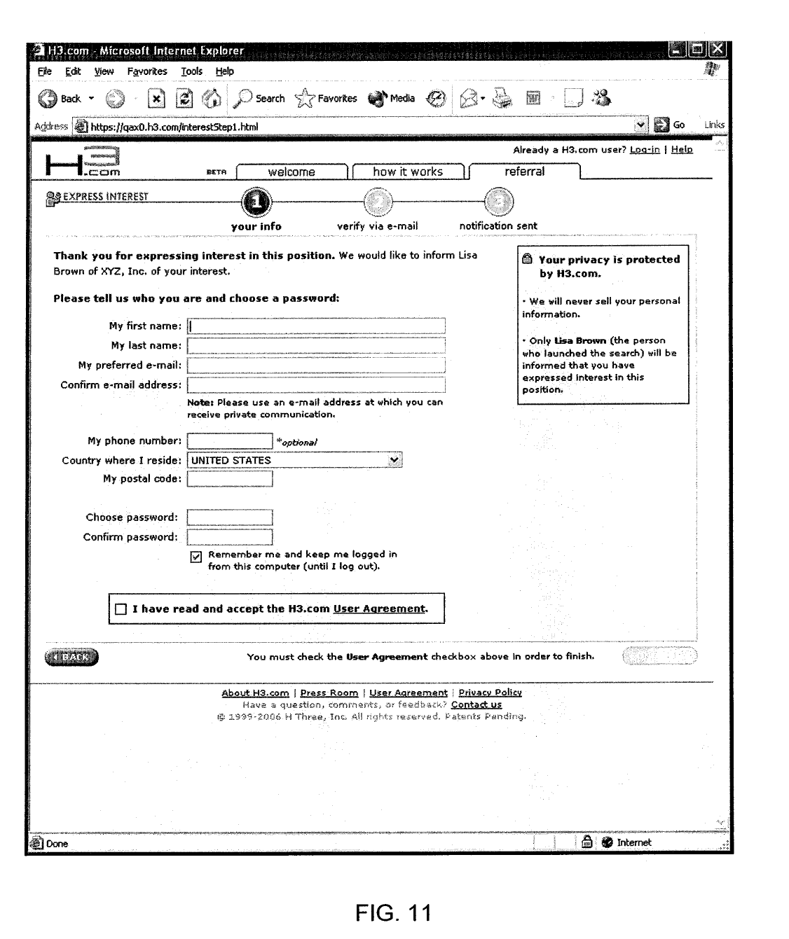

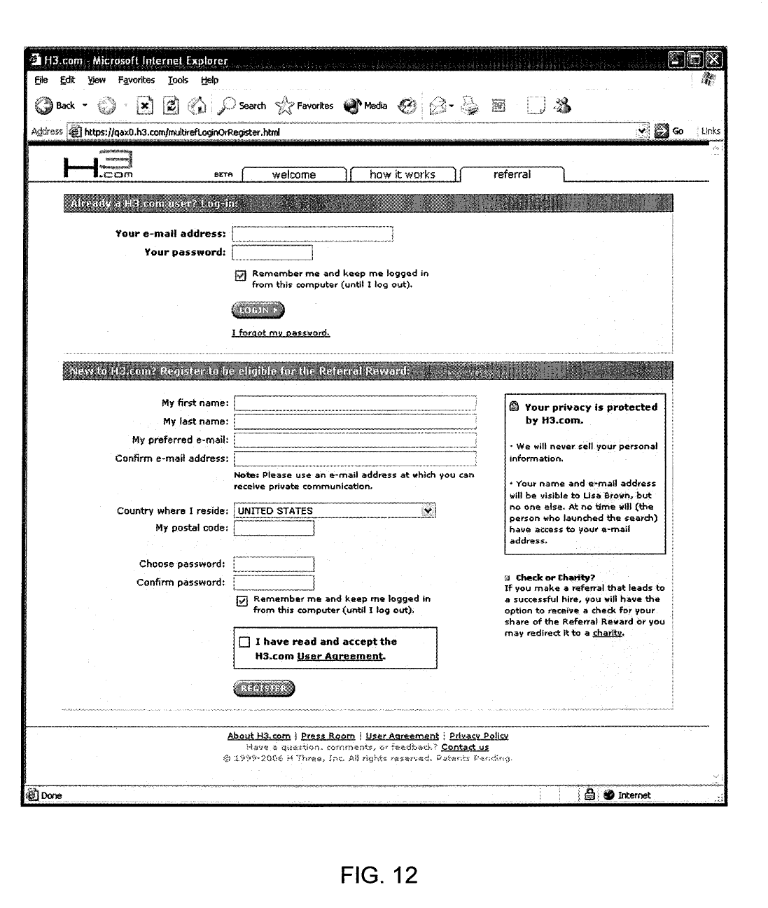

In any event, if a user who makes a request to the system by, e.g., operating controls of the type that the web pages depicted in FIGS. 9 and 10 is not known to the system, the system will not allow that user to refer any listings further or express interest in then until the system has collected information about the requester by using a web-page interface such as the ones that FIGS. 11 and 12 illustrate and create a new user identifier for the requester. In an embodiment in which a reward is associated with the listing and in which a requester qualifying for a reward has the option to direct the reward payment to a charity, the system may use a similar web-page interface to collect information from the requester about which charity should receive any reward for which the requester qualifies.

Before we consider what happens when a requester uses an interface such as that of FIG. 10 to request a multi-referral identifier, it will help to consider an additional feature. Although the listings shown in FIG. 10 are only the ones determined by the multi-referral identifier that the requester (here, Chris Johnson) received from a referring party (here, Lisa Brown) and sent the system to obtain the FIG. 10 web page, some embodiments may sometimes add listings besides those that the received multi-referral identifies.

To understand this optional feature, consider the example discussed here in connection with FIG. 2. Recall that, when Lisa Brown forwards Chris Johnson the multi-referral identifier associated with referral identifiers R1 and R2, she does so by sending a message incorporating multi-referral identifier M1 to Chris Johnson. As was explained above, Chris would then click on the hyperlink incorporating the multi-referral identifier and would thereby cause his browser to send the system a message incorporating the multi-referral identifier.

In accordance with this further feature, though, the system would then determine whether the requester already exists in its database of users. The system may make this determination by, for example, reading a cookie on the requester's computer or comparing information collected from the requester with information in its database (such as a user name and password). If a requester thereby identified has created listings, referred listings, or expressed interest in listings, then the web page this requester receives may include those listings in addition to the ones associated with the multi-referral identifier he submitted, and the requester can choose among them.

Since Chris has previously used the system to create listing L3, he is known to the system, so the listings presented by the web page that the system sends him include not only L1 and L2, which the identifier M1 that Lisa sent him specifies, but also L3, which he originated. So he is able to refer the listings received from Lisa (L1 and L2) and the listing that he originated for the job at ChrisCo (L3). In other embodiments, the system may use another basis to supplement the listings presented to a known user. For instance, a known user may inform the system that he wants to receive all listings posted by a chosen originator. In that case, the system may automatically supplement the listings show to the known user by adding any listing posted by that chosen originator. Alternatively, when the request to view any listings posted by the chosen originator is received from the known user, the system may first request authorization from the chosen originator before supplementing the listings shown to the known user with the listings posted by the chosen originator.

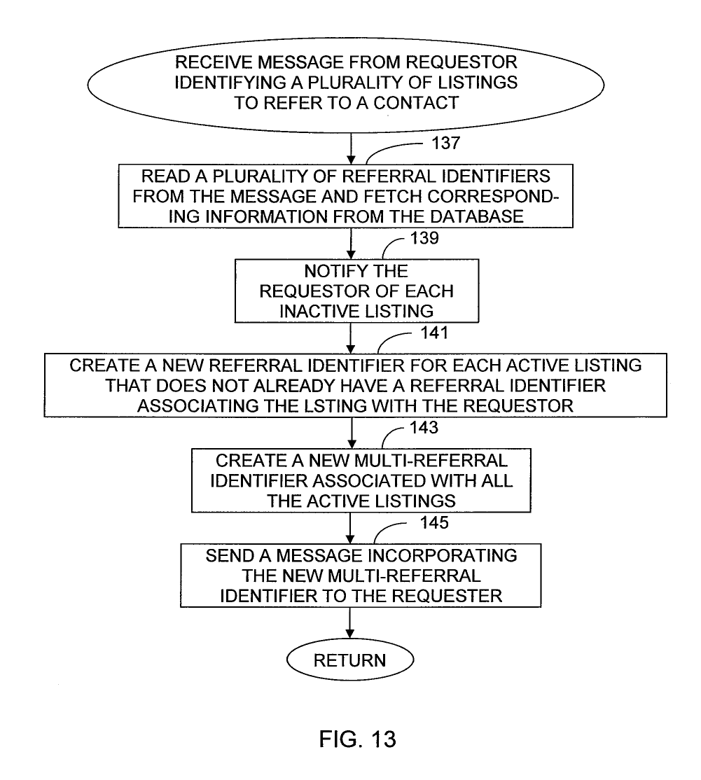

Let us therefore assume that in addition to the listings L1 and L2 that FIG. 10 shows Chris is additionally presented L3 and that he now requests a multi-referral identifier qualifying him as a referrer of listings L2 and L3. In the illustrated embodiment, upon receipt of the message identifying which listings the requester wants to refer, the referral tracking system executes a routine according to the flow chart of FIG. 13. In block 137, after receiving the message, the system reads the referral identifiers contained in the message and retrieves the corresponding information from the database. In the example of Chris requesting to refer the listings associated with listing identifiers L2 and L3, the system would retrieve the referral identifiers R2 and R3 from table 125 and listing identifiers L2 and L3 from table 123 of FIG. 2.

As block 139 indicates, after retrieving this information, the system may notify the requester of any inactive listings. Alternatively, the system may silently remove inactive listings without notifying the requestor. A listing may become inactive when, for example, it is withdrawn by the originator (because, e.g., all offered jobs have been filled, all offered items sold, etc.). In the illustrated database of FIG. 2, this information is stored along with the listing identifiers in table 123. Both of the listings that Chris is referring are still active, so the system will proceed to the next step without sending any notification to Chris.

The system then creates a new referral identifier for each active listing that does not already have a referral identifier associating that listing with the requester (block 141). In the example of FIG. 2, when Chris chooses to refer listings L2 and L3, the system responds to a message identifying those listings by generating referral identifier R4 and making a referral-table 125 entry that associates it with the listing identifier L2 (corresponding to Lisa's listing for an account manager in London), the user identifier U2 (corresponding to Chris), and the parent referral identifier R2 (which is the identifier by which Chris specified L2 as a listing for which he wanted a referral identifier designating hem the referrer). Of course, those skilled in the art are familiar with many other ways of recording child-parent relationships between objects, and some other embodiments may employ such other ways to designate the new identifier as a child of a previous identifier. The system does not need to create a new referral identifier for listing L3 since Chris is the originator of that listing and a referral identifier R3 already exists that associates the listing with Chris.

After creating these identifiers, a new multi-referral identifier is created that the system associates with all of the selected active listings (block 143). In the illustrated example, the system creates new multi-referral identifier M2 and places corresponding entries in tables 133 and 135 of FIG. 2. The entry in table 133 associates new identifier M2 with Chris (U2). The entries in table 135 associate new identifier M2 with single-referral identifiers R3 and R4.

Note that multi-referral identifier M2 identifies referrals whose lineages differ; the referral represented by R3 has no parent, whereas the one represented by R4 has as its parent the referral that R2 represents. So one cannot in general associate a single parent with a multi-referral identifier. To provide a related concept that can be single-valued, some embodiments may assign multi-referral identifiers a “source” property. That property, for example, may be the identifier that the requester of the multi-referral identifier used in requesting it. Other embodiments may identify the parent multi-referral identifier as the multi-referral identifier received by the requester that is associated with the largest number of listings also associated with the newly generated multi-referral identifier.

Having entered the new multi-referral in the database, the system sends the requester a message that incorporates it (block 145). The message may simply be displayed in the browser for the user to copy-and-paste into his own e-mail or web page. Alternatively, the message may, for example, be an e-mail message incorporating the new identifier. The requester can then send the e-mail message to any number of recipients who may be interested in the listings or know someone who is. These recipients may be selected from the requester's own personal contacts. This, again, allows the requester to select from his or her own address book those individuals who the requester believes would have interest in the listings and to refer them without the need to provide their contact information to the system. Thus, the requester can refer listings without compromising the confidentiality of his or her own personal-contact network.

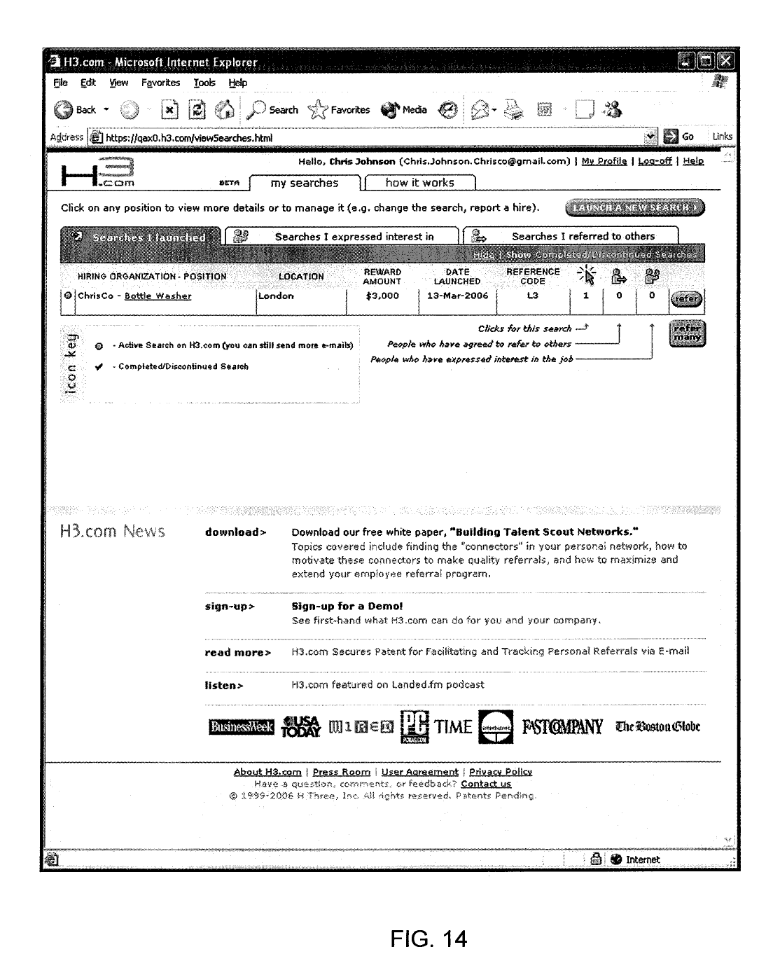

In the illustrated embodiment, a user who is known to the referral tracking system can at any time identify himself to the system and access the listings available for him to refer to others or express interest in. In the illustrated example, Chris, after requesting multi-referral identifier M2, can access listings L2 and L3 by logging into the system with his username and password since referral identifiers R3 and R4 in table 125 of FIG. 2 associate Chris with these listings. After logging in, Chris will be sent to a web page similar to the one illustrated in FIG. 14. This web page identifies Chris's created listings and allows Chris to view the listings in which he has expressed interest and the listings which he has referred to others by clicking on the appropriate tabs. In other embodiments, Chris may also be given the option to view listings he has saved for possible future use.

Saved listings might have been referred to the requester by an originator or other referring user, but at the time of the referral, the requester did not either want to express interest in the listings or refer the listings to a contact. The requester did, however, want to save the listings to possibly refer or express interest in them in the future. To facilitate saving a listing for future use, an embodiment of the system may provide a “save” button for each listing similar to the “express interest” buttons of FIG. 10. Upon pressing the “save” button, if the requestor is a new user, a new user identifier would need to be created for him. If the requestor has an existing user identifier, the system will try to identify the associated user identifier (such as through reading a cookie) or may request the requester to identify it to the system (such as by requiring a login). Alternatively, if the requester's user identifier is already known, the system may automatically save the listings. In any case, saving can be accomplished by creating an entry in the referrals table associating the requestor with the listing.

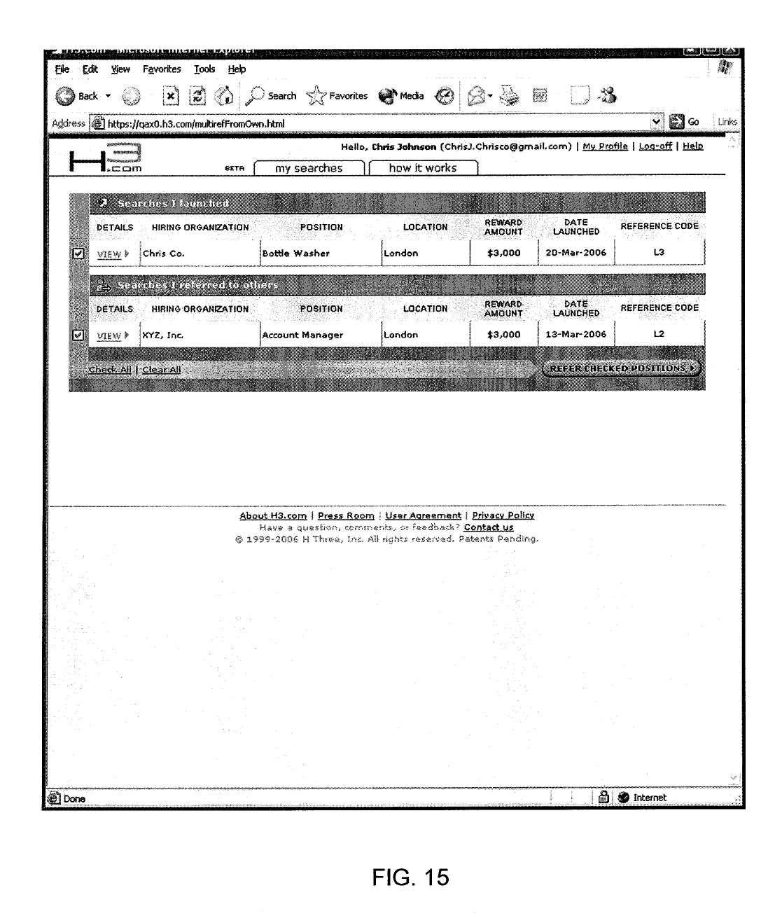

If Chris clicks on the “refer many” button illustrated in FIG. 14, he is sent to a web page such as the one illustrated in FIG. 15. Some embodiments of the present invention may not separate the interfaces of FIG. 14 and FIG. 15. In the illustrated embodiment, though, the web page illustrated in FIG. 15 allows Chris to select from any listing he has created, expressed interest in, or referred to another person in the past. (In the illustrated case, Chris has not previously expressed interest in any listing.) In embodiments that provide for saving listings, a similar web page may additionally or instead allow him to select from listings he has chosen to save, as discussed above. He can forward any combination of one or more such listings to a contact just as he did when he first received multi-referral identifier M1 from Lisa Brown and chose to request multi-referral identifier M2. This time, however, because Chris did not refer listing L1 before, no referral identifier exists that associates him with that listing. He is therefore not presented with the option of referring that listing further as is illustrated in FIG. 15

As is apparent from the previous discussion, the system tracks parent-child relationships between referrals by entering information into table 125 of FIG. 2. If a requester sends such a message, for example, by clicking the “refer checked positions” button of FIG. 10, the system may accept that requester as a new referrer of the listing and the system will generate the new referral identifier as representing a child of a referral represented the referral identifier that was sent to the requester. These entries allow the system to track a referral chain for any given listing by examining the entries in table 125 of FIG. 2.

Referral-identifier generation in some embodiments may not always involve creating a new UUID for each originator or requester, as the illustrated embodiment does. It may, for instance, merely comprise combining different existing component identifiers. And the present invention's teachings do not require that the stored information be organized in tables or that any tables that are used be arranged as those of FIG. 2 are. But every embodiment will take the information in some way that enables it to track a respective chain of referral identifiers from each recipient back to the initial issuance of a referral or multi-referral identifier associated with the listing.

Different embodiments may infer different topologies of a referral chain from the same set of user actions. This can result from differing approaches to enforcing identifier uniqueness, or, viewed another way, to what a referral identifier is considered to be. To appreciate this, consider as a first embodiment a multiple-listing referral-tracking system that supports the following operational scenario. First, an originator O is issued multi-referral identifier M1 associated with referral identifiers R1, R2, and R3 and sends it to acquaintances A and B. Second, A, using multi-referral identifier M1, chooses to obtain his own identifier to refer the listings associated with R1 and R2 further. A is accordingly issued a multi-referral identifier M2 associated with referral identifiers R4, which represent a child of the referral that RI represents, and R5, which represents a child of the referral that R2 represents, and sends the multi-referral identifier to acquaintance B.

Third, B (reading his topmost e-mail message, the one from A) using multi-referral identifier M2, chooses to obtain his own identifier to refer the listing associated with L1 further. B is issued referral identifier R6 that represents a child of the referral represented by R4 and sends it to acquaintance C. Fourth, B (after reading the lower-down e-mail message from O) using multi-referral identifier M1, chooses to refer the listing associated with L1 again. B obtains referral identifier R7, which represent a child of the referral represented by R1 and sends it to D, who takes the job.

For the sake of example, we assume here that the system uses referral tables of the type that FIG. 2 depicts. The actions just described cause the first embodiment under consideration to place seven entries into the referral table, namely, a respective entry for each of the referral identifiers R1, R2, R3, R4, R5, R6, and R7. Note that, although each referral identifier is associated with a corresponding user and listing, the associations of user-listing combinations with identifiers are not unique; the entries for R6 and R7 have the same user-listing combination. In this first embodiment, that is, the concept of referral can be thought of a coupled only loosely to that of which user is doing the referring. And, without more, the referral chain would be deemed to be O-B-D, because R1 is the parent of R7, which is the identifier that D received: B alone would get the reward (if the originator cannot share).

Other embodiments may be so arranged as to couple the concepts of referral and referrer more tightly. For example, consider as a second example embodiment one whose response to B's second request—i.e., to a request for a second referral identifier associated with the same combination of user and listing—would be to deny the request or, what amounts to the same thing, just send B the same referral identifier it sent him previously. In that case, the referral chain would be deemed to be O-A-B-D: A and B would share the reward. Note that in this embodiment the parent-child relationships between referrals are equivalent to parent-child relationships between users. To emphasize that, FIG. 2's table 125 includes a “parent user” column even though that column's information is redundant in view of the “parent identifier.”

The chains begin with the person to whom the system issues the first referral identifier. We refer here to that person as the “originator,” and with respect to listing L1 and L2, the originator is Lisa in the FIG. 2 example. Chris is an originator with respect to listing L3. The next person in each chain is a requester to whom the originator directly sent a message that incorporated an identifier associated with the listing. With respect to listing L1 and L2 in FIG. 2, Chris is such a person. Subsequent links in the chain include requesters who received referral-containing messages sent by other requesters. There may be multiple referral chains, since any requester may elect to refer one or more listings to multiple further recipients, each of whom may in turn refer some or all of the listings to still further recipients. As noted above, the system maintains a database of all identifiers associated with a particular listing as well as all requesters who have either further referred or expressed interest in a listing. Such a database may further associate each referral identifier with its parent referral identifier, as illustrated in table 125 in FIG. 2.

Different embodiments may differ in how much information they share with the originator. For example, by logging into the system and reviewing the status of a listing, the originator may be provided with information about the number of times the listing was referred (i.e., the number of child referral identifiers generated), but not the names of the requesters who referred the listing. In another exemplary embodiment, the originator may be shown the names of the requesters directly linked to the originator, but not the names of requesters further along the referral chains. In this way, the originator may obtain information about how many additional unique identifiers have been requested, while the confidentiality of subsequent requesters' contact networks is preserved. Alternatively, if confidentiality is not required, the originator may be shown the complete referral chains.

The system may allow the originator to look at referrals in a multi-referral context if they have been referred in such a way. For example, to help an originator determine effective groupings of job listings, the system may allow an originator to see what other listings have been grouped with a particular listing. This may help an originator determine which type of job listings out of a large group of listings are being referred and design listings and groupings accordingly.

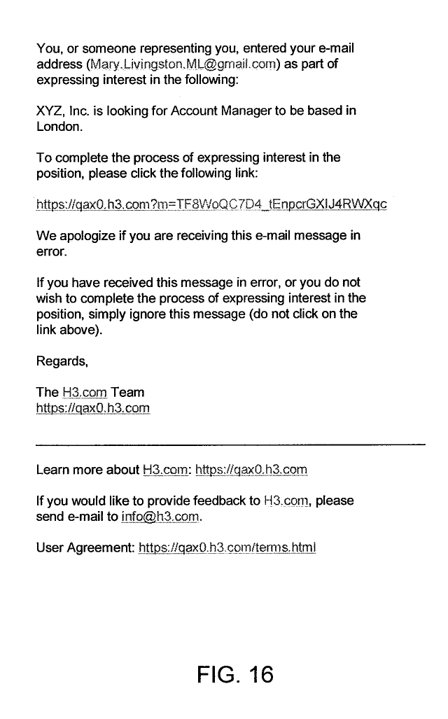

When a requester chooses to express interest in a listing (by, for example, clicking on FIG. 9's or FIG. 10's “express interest” buttons), the system may collect information about the requester to provide to the originator; FIG. 11 illustrates a web-page interface for collecting such information. In an exemplary embodiment, once the system has collected information about the requester interested in the position, the system may send a confirmation e-mail to an address provided by the requester in order to confirm the requester's interest and e-mail address before notifying the originator of the requester's interest. The confirmation e-mail may include a hyperlink incorporating an identifier associated with the listing and the requester. (FIG. 16 depicts an exemplary confirmation e-mail.)

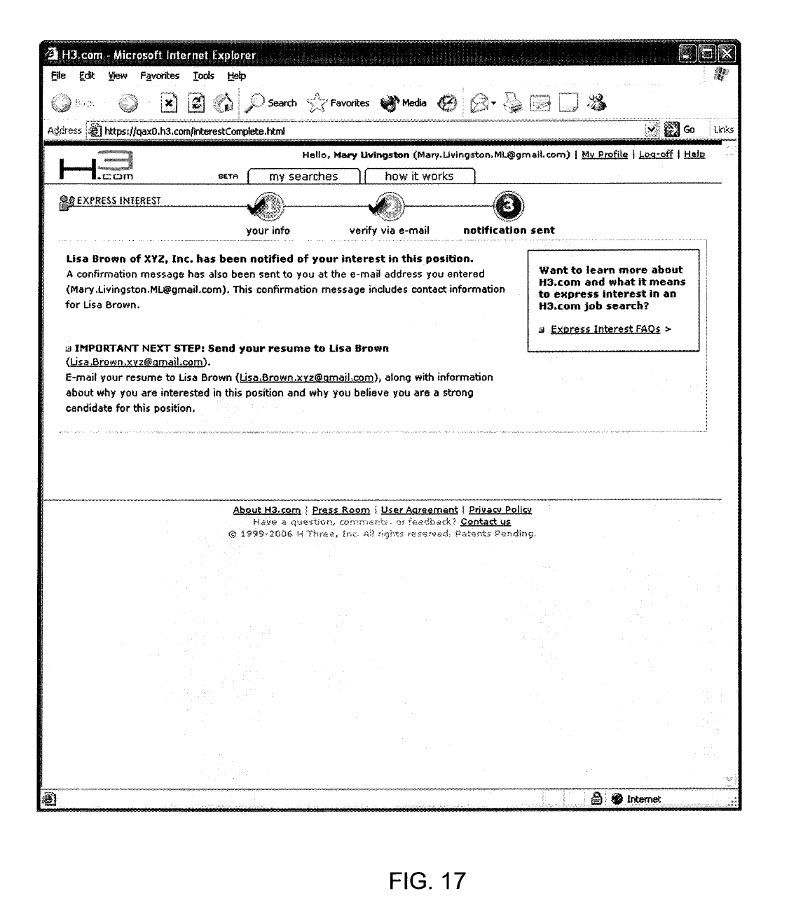

When the requester clicks on the hyperlink (or copies its referred-to URL into the address bar of a web browser), a message that contains the incorporated identifier is sent to the system. Upon receipt of that message the system may notify the originator of the requester's interest in the listing by, for example, sending a notification e-mail to the originator. In an exemplary embodiment, the system provides the interested requester with a web page indicating that the originator has been notified of the requester's interest, as FIG. 17 illustrates. The originator may then contact the interested requester at the e-mail address the requester provided.

In the illustrated embodiment, previous requesters are not notified that a subsequent requester has expressed interest in the listing, although they may be in other embodiments. In the illustrated embodiment, a requester expresses interest in one listing at a time even if many similar listings are available to him. In other embodiments, a requester may be able to check a box next to each listing in which the requester is interested and simultaneously express interest in all of those listings by sending the information entered by the requester to an originator associated with each checked listing.

When a listing has been fulfilled or partially fulfilled (e.g., when some or all jobs in the listing have been filled, the listed real estate sold, etc.), the originator may log in to the system and change the status of the listing to reflect that it has been fulfilled or partially fulfilled and/or to reflect which requester took a listed position. Some embodiments may be so arranged that a requester (for example, a requester ultimately hired to fill a listed position) can claim that the status of the listing should be changed to reflect that a listed position has been taken. In such an embodiment, the system would typically send to the originator a confirmation e-mail inviting the originator to confirm that a listed job has been filled, and the originator may do that by, e.g., clicking on a hyperlink the e-mail contains or logging into the system. The originator may also withdraw a listing or otherwise change its status for any reason at any time. For example, an originator may wish to temporarily suspend a search for candidates in order to have an opportunity to interview those candidates already identified. Therefore, in some embodiments, the system may permit the originator to temporarily designate a listing as inactive and at a later time change the listing's status back to active. In the illustrated embodiment, each listing entry in the data table 123 includes an entry indicating the listing's status (i.e., telling whether that listing is active, inactive, withdrawn, etc.).

There are circumstances in which it is desirable for the system to generate a set of all user identifiers or referral identifiers in a chain leading from the originator to a particular requester. Such a set will be described herein as the set of “ancestors” of a given identifier. An identifier is a given identifier's ancestor if it is the given identifier's parent or an ancestor of the given identifier's parent. It may similarly be desirable for the system to generate a set of “offspring” identifiers in one or more chains leading from a particular requester to subsequent requesters. An identifier is a given identifier's offspring if it is the given identifier's child or an offspring of the given identifier's child. Each referral identifier associated with a multi-referral identifier may have the same or a different set of ancestors and offspring.

The system may compute the set of ancestors and/or offspring in response to a request for information about the status of a listing's referral chain. The set of ancestors and/or offspring may then be used to provide that information to the originator. In addition, the system may use a set of ancestors to determine the distribution of a reward. When the system is informed that a requester has been hired for a listed job, it is thereby at least implicitly informed of which referral chain led to that requester. When the system is informed of which applicant fulfilled the listing, it finds that applicant in that listing's applicant list and thereby identifies the referral that was the fulfillment's proximate cause. It then identifies that referral identifier's ancestors and uses the resultant ancestor set to generate an output. The system may also be arranged to generate an output based on an ancestor set and/or an offspring set for other reasons.

The output can take many forms. In some cases, for example, it may be an indication of how effective various people are as referrers. In the illustrated example, though, the output is an indication of how the reward is to be shared. The simplest approach is for each referrer listed in an ancestor referral to receive an equal share of the award. But the system may instead award unequal shares, and outside information may be relied on to arrive at the distribution. For example, the system may refer to a database of all requesters who have made referrals in the past, and provide eligible requesters with a share proportional to the number of listings they have previously forwarded. Any other method of apportioning shares of the reward among requesters in the branch of the referral tree connecting the originator to the requester who fulfilled the listing may be employed.

Occasionally, more than one referral may be identified as the proximate cause of the fulfillment: more than one branch of the referral tree may connect the originator to the requester who fulfilled the listing. In such a case, the reward may be distributed either to the requesters in branches leading to the requester who fulfilled the listing, or say, only among the requesters in the branch that was activated first. For example, if an originator forwards a referral-identifier-containing message to requesters A and B, who both elect to forward the listing to C, C will receive two referral-identifier-containing messages: one message from A, containing a hyperlink incorporating a referral identifier associated with the listing and with A; and one message from B, containing a hyperlink incorporating an identifier associated with the listing and with B. If C clicks on one of the hyperlinks, elects to express interest in the listing, and eventually fulfills the listing, whether the reward goes to A or B is determined, in an exemplary embodiment, by whether the identifier incorporated in the hyperlink that C clicked on was from A's or B's branch of the tree. If C clicked on both A's and B's hyperlinks, the system may assign the reward to both branches or only to one (for example, the branch of the tree that C clicked on first).

As was stated above, the system may use a web-page interface rather than an e-mail message to send the referral or multi-referral identifier to the originator. For example, this may be done by sending the user's browser a web page that, e.g., displays the URL for the originator to copy and paste into one or more e-mails sent to one or more recipients to whom the originator wishes to refer the listing or listings. The URL may be displayed along with additional text the originator may also copy and paste into e-mails sent to referred recipients.

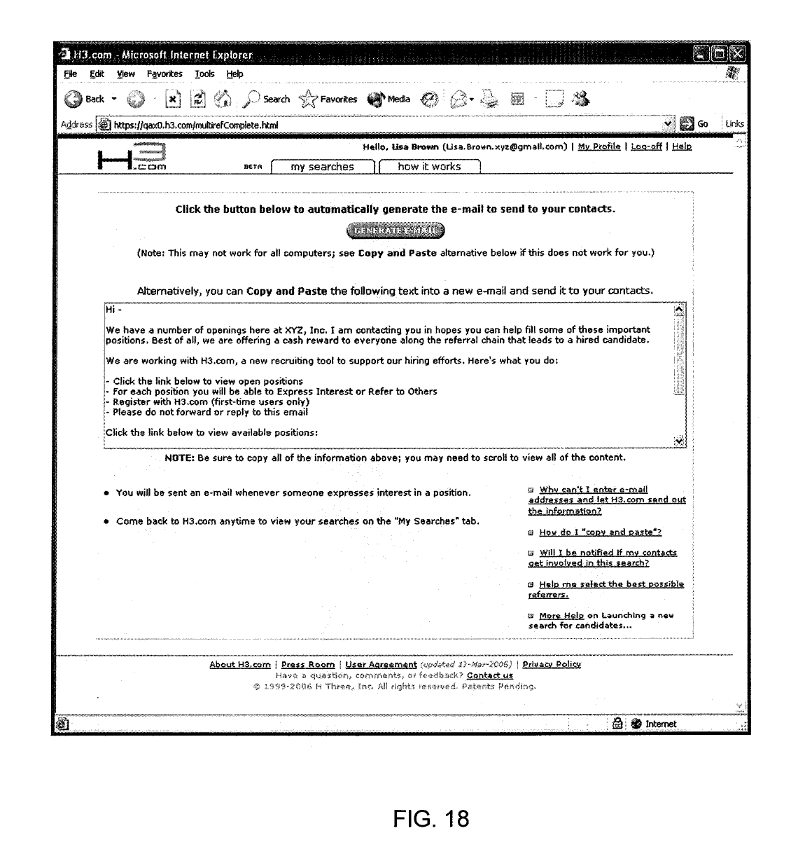

FIG. 18 depicts an example of a web page that includes the identifier-incorporating URL. That web page provides the originator with the option of copying text that includes the URL and pasting it into e-mails sent by the originator to recipients to whom the originator wishes to refer a listing or listings. The illustrated web page also provides a “generate e-mail” button that the originator can click to instruct the system to automatically generate an e-mail message containing the displayed text (including the URL). This illustrated web page specifies to a receiver that the originator is looking for a person to fill some listings. In one embodiment, when the “generate e-mail” button (or its equivalent) is clicked, the system will instruct the originator's web browser to invoke the originator's e-mail program (or other e-mail system) and instruct the e-mail program to generate the e-mail message. In an exemplary embodiment, the originator's e-mail program is invoked via the HTTP “mailto” command, i.e. embedded in a link in the displayed web page. Once the originator's e-mail program is invoked, the originator may then enter the e-mail addresses of one or more recipients and send the e-mail message.

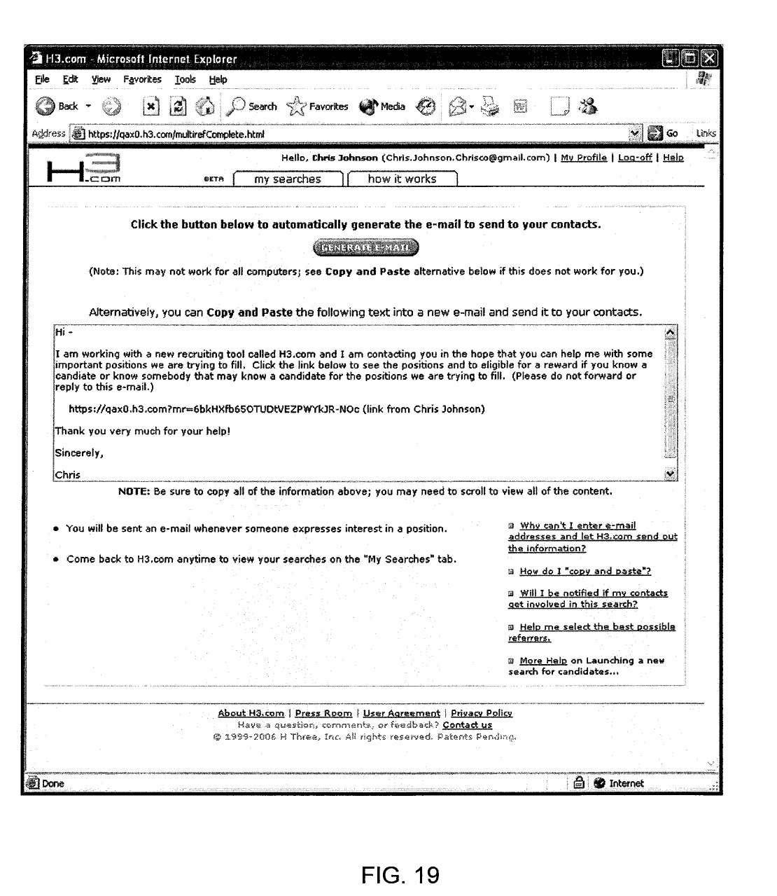

Similarly, exemplary embodiments may provide requesters who wish to make further referrals with the same option either to copy (from a web page displayed on the recipient's web browser) text including the URL incorporating the single- or multi-referral identifier and paste it into an e-mail message, or to generate automatically an e-mail message having that text using a “generate e-mail” button (or its equivalent). An illustrative web page displaying these options is shown in FIG. 19. This illustrated web page, unlike the web page of FIG. 18, does not indicate what party is looking to fill the listings.

Now, one way in which sending the referral or multi-referral identifier by web-page transmission differs from sending it by e-mail is that web-page transmission does not provide automatic e-mail-address verification. In the e-mail approach to sending the identifier, the originator receives the identifier only if he has entered his e-mail address correctly, but the same cannot be said of the web-page approach, and such verification may be desirable. One way to provide it in the web-page approach involves implementing the listing-submission operation in multiple steps rather than the single step that FIG. 5's block 127 suggests.

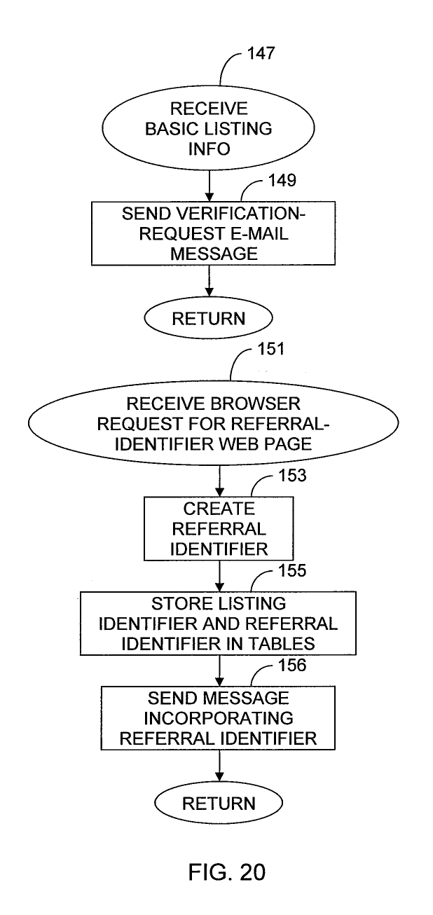

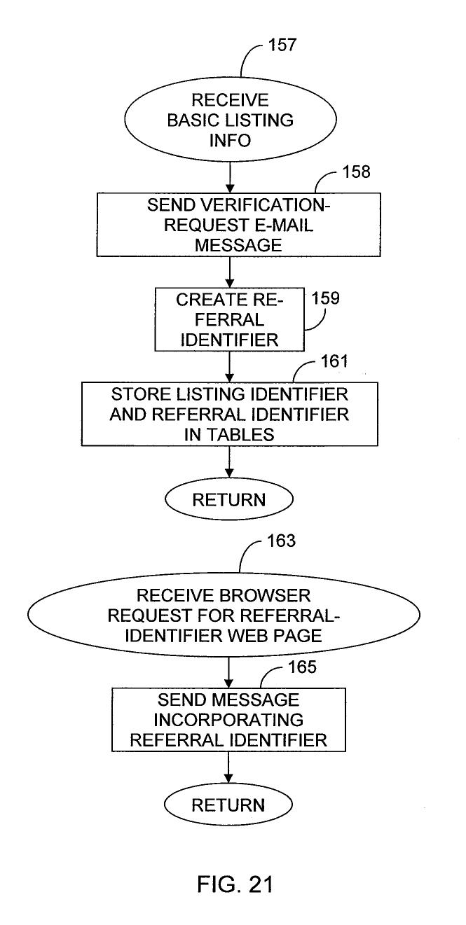

FIGS. 20 and 21 give examples. These drawings are flow charts of exemplary routines for adding an additional, e-mail address-verification step to the listing-submission operation. As blocks 147 and 149 indicate, the server in the FIG. 20 approach responds to receipt of initial information by sending the originator an e-mail message containing the URL of a web page to which he must direct his browser in order to verify that the originally submitted e-mail address is correct. As blocks 151, 153, 155, and 156 indicate, it is only after receiving the resultant web page request that the system completes its response to a listing submission. As discussed above, a listing submission can in some embodiments, as in the illustrated one, be limited to one listing per submission. In other embodiments, an originator can submit multiple listings in one submission.

In the FIG. 21 approach, not only is the listing submission similarly divided into more than one step, but the server's response is divided into a portion that is triggered by the first submission step independently of whether the second submission step also occurs. In the approach of FIG. 21, the server not only sends the verification-request e-mail message in response to submission of initial listing information, as blocks 157 and 158 indicate, but also creates the referral identifier and stores the listing(s) and referral identifier(s) in the table, as blocks 159 and 161 indicate. But, as blocks 163 and 165 indicate, the server does not send the referral identifier(s) to the originator until the originator has sent the server the verification response by, e.g., clicking on a link in the verification-request e-mail message and thereby causing his browser to request the proper identifier-containing web page. In some embodiments that allow multiple listings to be submitted at one time, the system may create and send a multi-referral identifier.

If desired, similar e-mail verification may also be employed prior to providing referral keys to recipients who wish to refer one or more listings to other recipients. Other verification measures known in the art may also be employed prior to providing an originator or a recipient with a message containing a URL incorporating a referral or multi-referral identifier, or prior to accepting a recipient's expression of interest in one or more listing. For example, to prevent the automated creation of and response to listings, the system may display a web page containing a verification image (such as a captcha) and require an originator or recipient to enter text from the verification image.

By using the present invention's teachings, a user can selectively group listings together and refer the group to a contact by using a multi-referral identifier. Therefore systems that employ the present invention's teachings can often elicit participation more effectively than conventional systems can.

What is claimed is:

1. A computer system configured as a referral-tracking system operable to:
A) issue referral identifiers, each of which the referral-tracking system associates with a referrer and at least one listing, each referral representing, for each listing associated therewith, a respective referral thereof by the referrer associated with that referral identifier, the referral-tracking system being operable to issue some said referral identifiers as multiple-referral identifiers, with each of which the referral-tracking system associates a plurality of listings whose referrals by the referrer is represented by that multiple-referral identifier;
B) in response to receiving from a requester such a multiple-referral identifier and a request for a a further referral identifier, one that represents referral by the requester of at least one of the listings whose referral the multiple-referral identifier requests:
i) sends the requester a message that incorporates such a further referral identifier; and
ii) records a child-parent relationship between (a) each listing's referral represented by the further referral identifier and (b) the same listing's referral represented by the received multiple-referral identifier;
C) use receipt by the referral-tracking system of the referral identifiers it has issued to track a chain of referrals of the listings in accordance with the recorded child-parent relationships; and
D) generate one or more chain-dependent outputs that it determines from the chain of referrals thereby tracked.

2. The computer system of claim 1 wherein:
A) the referral-tracking system accepts from originators listing-submission inputs that define listings; and
B) the listings whose referrals the referral identifiers represent are selected s from among the listings thus defined.

3. The computer system of claim 2 wherein, in at least some circumstances in which a given said listing whose referral a given said multi-referral identifier represents is active, the referral-tracking system, in response to receiving from a recipient one or more messages that together incorporate the given multi-referral identifier and express the recipient's interest in the given listing, gives notice of that recipient's interest in the given listing to the originator from which the referral-tracking system received the originator input that defined that listing.

4. The computer system of claim 2 wherein the referral-tracking system:
A) accepts an input representing a said originator's e-mail address;
B) in at least some circumstances sends to the originator's e-mail address a message that includes instructions for verification of the originator's e-mail address; and
C) sends the originator a message incorporating a referral identifier for any listing submitted by that originator only if that originator verifies the originator's e-mail address in accordance with the instructions.

5. The computer system of claim 1 wherein the message is an e-mail message.

6. The computer system of claim 5 wherein the e-mail message includes at least one Uniform Resource Locator (URL) incorporating at least one said referral identifier incorporated in the e-mail message.

7. The computer system of claim 6 wherein the at least one referral identifier is incorporated in the at least one URL at least in part as a parameter.

8. The computer system of claim 1 wherein the message is a web page.

9. The computer system of claim 8 wherein the web page includes at least one URL incorporating at least one said referral identifier incorporated in the web page.

10. The computer system of claim 9 wherein the at least one referral identifier is incorporated in the at least one URL at least in part as a parameter.

11. The computer system of claim 1 wherein the referral-tracking system generates a said chain-dependent output in at least some circumstances in response to a fulfillment input indicating that one or more of the listings have been at least partially fulfilled.

12. The computer system of claim 11 wherein the chain-dependent output specifies a respective award amount for each referrer in a set thereof determined by a chain of referrals of a listing indicated by the fulfillment input to have been at least partially fulfilled.

13. The computer system of claim 11 wherein:
A) the fulfillment input specifies a referral that resulted in the at least partial fulfillment; and
B) the output is based on a set that comprises every ancestor of the referral s thereby specified.

14. The computer system of claim 1 wherein the referral-tracking system generates a said chain-dependent output in at least some circumstances in response to an input representing a request for the status of a referral chain.

15. The computer system of claim 1 wherein at least one of the listings is a job listing.

16. The computer system of claim 1 wherein, in at least some circumstances in which a given said listing whose referral a given said multi-referral identifier represents is active, the referral-tracking system, in response to receiving from a recipient one or more messages that together incorporate the given multi-referral identifier and express the recipient's interest in the given listing, gives notice of that recipient's interest in the given listing to the originator from which the referral-tracking system received the originator input that defined that listing.

17. The computer system of claim 1 wherein:
A) in response to receipt of a multiple-referral identifier issued thereby, the referral-tracking system sends the requester a message whose contents the requester can use to make and send the referral-tracking system a selection of at least one listing from among a group of listings that includes those whose referrals the multiple-referral identifier represents; and
B) the further referral identifier represents a referral of each listing thereby selected.

18. A storage medium that contains machine instructions readable by a computer system to configure the computer system as a referral-tracking system operable to:
A) issue referral identifiers, each of which the referral-tracking system associates with a referrer and at least one listing, each referral representing, for each listing associated therewith, a respective referral thereof by the referrer associated with that referral identifier, the referral-tracking system being operable to issue some said referral identifiers as multiple-referral identifiers, with each of which the referral-tracking system associates a plurality of listings whose referrals by the referrer is represented by that multiple-referral identifier;
B) in response to receiving from a requester such a multiple-referral identifier and a request for a a further referral identifier, one that represents referral by the requester of at least one of the listings whose referral the multiple-referral identifier requests:
i) sends the requester a message that incorporates such a further referral identifier; and
ii) records a child-parent relationship between (a) each listing's referral represented by the further referral identifier and (b) the same listing's referral represented by the received multiple-referral identifier;
C) use receipt by the referral-tracking system of the referral identifiers it has issued to track a chain of referrals of the listings in accordance with the recorded child-parent relationships; and
D) generate one or more chain-dependent outputs that it determines from the chain of referrals thereby tracked.

19. The storage medium of claim 18 wherein:
A) the referral-tracking system accepts from originators listing-submission inputs that define listings; and
B) the listings whose referrals the referral identifiers represent are selected from among the listings thus defined.

20. The storage medium of claim 19 wherein, in at least some circumstances in which a given said listing whose referral a given said multi-referral identifier represents is active, the referral-tracking system, in response to receiving from a recipient one or more messages that together incorporate the given multi-referral identifier and express the recipient's interest in the given listing, gives notice of that recipient's interest in the given listing to the originator from which the referral-tracking system received the originator input that defined that listing.

21. The storage medium of claim 19 wherein the referral-tracking system:
A) accepts an input representing a said originator's e-mail address;
B) in at least some circumstances sends to the originator's e-mail address a message that includes instructions for verification of the originator's e-mail address; and
C) sends the originator a message incorporating a referral identifier for any listing submitted by that originator only if that originator verifies the originator's e-mail address in accordance with the instructions.

22. The storage medium of claim 18 wherein the message is an e-mail message.

23. The storage medium of claim 22 wherein the e-mail message includes at least one Uniform Resource Locator (URL) incorporating at least one said referral identifier incorporated in the e-mail message.

24. The storage medium of claim 23 wherein the at least one referral identifier is incorporated in the at least one URL at least in part as a parameter.

25. The storage medium of claim 18 wherein the message is a web page.

26. The storage medium of claim 25 wherein the web page includes at least one URL incorporating at least one said referral identifier incorporated in the web page.

27. The storage medium of claim 26 wherein the at least one referral identifier is incorporated in the at least one URL at least in part as a parameter.

28. The storage medium of claim 18 wherein the referral-tracking system generates a said chain-dependent output in at least some circumstances in response to a fulfillment input indicating that one or more of the listings have been at least partially fulfilled.

29. The storage medium of claim 28 wherein the chain-dependent output specifies a respective award amount for each referrer in a set thereof determined by a chain of referrals of a listing indicated by the fulfillment input to have been at least partially fulfilled.

30. The storage medium of claim 28 wherein:
A) the fulfillment input specifies a referral that resulted in the at least partial fulfillment; and
B) the output is based on a set that comprises every ancestor of the referral thereby specified.

31. The storage medium of claim 18 wherein the referral-tracking system generates a said chain-dependent output in at least some circumstances in response to an input representing a request for the status of a referral chain.

32. The storage medium of claim 18 wherein at least one of the listings is a job listing.

33. The storage medium of claim 18 wherein, in at least some circumstances in which a given said listing whose referral a given said multi-referral identifier represents is active, the referral-tracking system, in response to receiving from a recipient one or more messages that together incorporate the given multi-referral identifier and express the recipient's interest in the given listing, gives notice of that recipient's interest in the given listing to the originator from which the referral-tracking system received the originator input that defined that listing.

34. The computer system of claim 18 wherein:
A) in response to receipt of a multiple-referral identifier issued thereby, the referral-tracking system sends the requester a message whose contents the requester can use to make and send the referral-tracking system a selection of at least one listing from among a group of listings that includes those whose referrals the multiple-referral identifier represents; and
B) the further referral identifier represents a referral of each listing thereby selected.
